(19) United States
(12) Patent Application Publication
(10) Pub. No.: US 2022/0205862 A1
(43) Pub. Date: Jun. 30, 2022

(54) FLEXIBLE TAPE FOR USE IN LEAK DETECTION

(71) Applicant: DRIPP AB, Uppsala (SE)

(72) Inventor: Anton REHNSTRÖM, Uppsala (SE)

(73) Assignee: DRIPP AB, Uppsala (SE)

(21) Appl. No.: 17/606,569

(22) PCT Filed: Apr. 30, 2020
(86) PCT No.: PCT/SE2020/050435

§ 371 Date: Oct. 26, 2021

(30) Foreign Application Priority Data
May 3, 2019 (SE) 1950527-0

(51) Int. Cl. G01M 3/16; G01M 3/04; G01M 3/12

(52) U.S. Cl. CPC G01M 3/165; G01M 3/12; G01M 3/045

(57) ABSTRACT

The present invention relates to a flexible tape (41;50) for use in detecting liquid leaks comprising an elongated substrate (44), having a length (L), a top surface (44a) and a bottom surface (44b), formed from a moisture absorbent material. The flexible tape further comprises at least one non-moisture absorbent electrically insulating material (45.46; 52) disposed on the top surface (44a), and first and second electrical conductors (47,48) spaced via the electrically insulating material (45,46; 52). The invention also relates to a leak detection system (80) and method for detecting a presence of an electrically conductive liquid.

### TECHNICAL FIELD

The present invention relates to a flexible tape designed for use in detecting leak in a leak detection device. The invention also relates to a leak detecting system and a method for detecting leak.

### BACKGROUND

Leakage through the roof is a common problem, especially around feed-throughs (such as ventilation conduits, drainage, etc.). These types of feed-throughs are the main reason for roof leakage (roughly about 75%) mainly due to poor installation of roofing materials.

FIG. 1a illustrates drainage on a flat roof and FIG. 1b illustrates ventilation on an angled roof top. These figures illustrate typical situations when water leaks through the roof, as indicated by the arrows, and cause damages to the underlying structure.

U.S. Pat. No. 6,175,310 discloses a tape used to detect leaks that comprises a moisture absorbent substrate upon which two spaced conductor are provided. A leak detection circuit is also disclosed that is configured to detect the presence of an electrically conductive fluid bridging the conductors. A drawback with the disclosed system is that condensation that may occur may unintentionally be detected as a leak.

Thus, there is a need to improve detection of leaking fluids, such as water, to prevent damages to underlying structure, i.e. roof, beams, walls, etc.

### SUMMARY

An object of the present disclosure is to provide a leakage detection system which seek to mitigate, alleviate, or eliminate one or more of the above-identified deficiencies in the art and disadvantages singly or in any combination.

The object is achieved by a method as defined by the independent claims.

An advantage is that condensation due to temperature differences may not be erroneously indicated as a leak.

Another advantage is that any type of installation having a risk for water leakage may easily be retrofitted with the leak detection system.

Further objects and advantages may be obtained from the detailed description by a skilled person in the art.

### BRIEF DESCRIPTION OF THE DRAWINGS

FIGS. 1a and 1 b illustrate situations when leakage in a roof may be a problem.

FIGS. 2a and 2b illustrate a prior art tape and leak detecting device.

FIG. 3 illustrates the drawback of the leak detecting device in FIGS. 2a and 2b.

FIG. 4 illustrates a first example of a tape and leak detecting device according to the present invention mounted on a conduit with annular cross-section.

FIG. 5 illustrates a second example of a tape according to the present invention.

FIG. 6 illustrates a leak detecting device according to the present invention mounted on a ventilation shaft with rectangular cross-section.

FIG. 7 illustrates a leak detecting device mounted to a pipe using a clamp.

FIG. 8 illustrates a leak detection system with three leak detecting devices.

FIG. 9 illustrates the leak detection system implemented in a building.

FIG. 10 illustrates a third example of a tape according to the present invention.

FIG. 11. shows a cross-sectional view of the tape in FIG. 10.

FIG. 12 illustrates an alternative embodiment of the tape in FIG. 5.

FIG. 13 illustrates a flow chart of a method for detecting a leak.

### DETAILED DESCRIPTION

The present invention relates to a device that is able to detect the presence of fluids in connection with a feed-through through a surface, such as a roof of a building, i.e. leakage through a roof of a house.

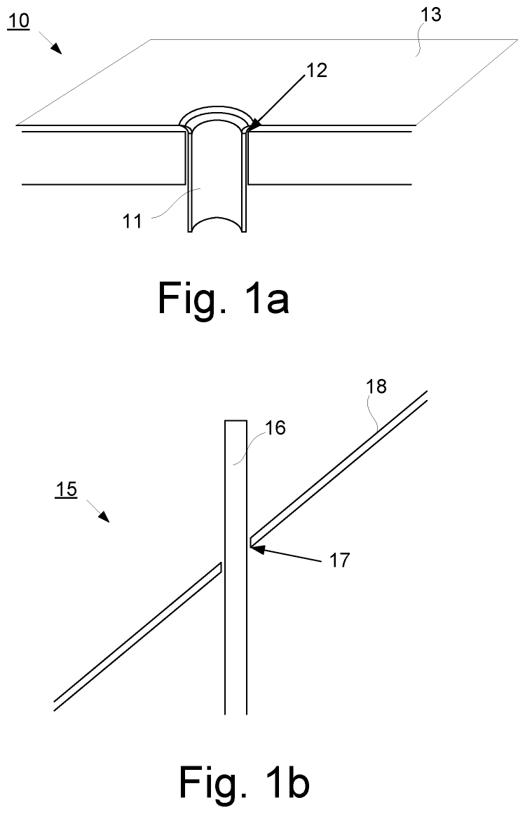

FIG. 1a illustrates drainage 11 on a flat roof 13 and FIG. 1b illustrates ventilation 16 on an angled roof top 18. These figures illustrate typical situations when water leaks through the roof, as indicated by the arrows 12 and 17, respectively, and cause damages to the underlying structure.

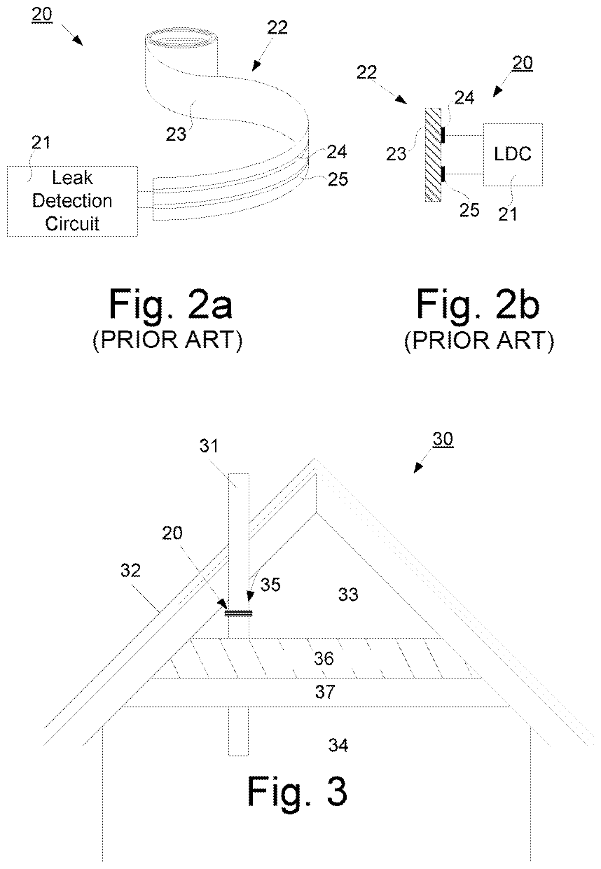

FIGS. 2a and 2b illustrate a prior art leak detecting device 20 comprising a leak detecting circuit, LDC, 21 and a flexible tape 22. The flexible tape comprises a moisture absorbent substrate 23 and two parallel conductors 24, 25, which are spaced apart. The LDC 21 is configured to detect the presence of a conductive fluid between the conductors 24 and 25. Since the substrate 23 is moisture absorbent, a continuous supply of water will be absorbed by the substrate 23 and eventually cause a short circuit between the conductors 24 and 25. This will indicate a leak, although the indication may be caused by condensation which may not be harmful for the underlying structure.

Early detection of leakage will minimize damage on roofing structure, and this will in turn reduce cost to attend to the leaking feed-through and eliminate the problem. However, condensation that will occur under certain conditions should not indicate a leakage unless the condensation is severe.

FIG. 3 illustrates the drawback of the leak detecting device described in connection with FIGS. 2a and 2b when installed around a ventilation conduit 31 through the roof 32 of a building 30. The temperature difference between the outside, the attic 33 and indoors 34 will create a situation where there is a risk for condensation in the attic 33, as indicated by arrow 35. The moisture absorbent substrate 21 of the leak detecting device 20 will over time absorb the condensation and most certainly cause the LDC to indicate a leak. Condensation is normal for this type of situation and the excess humidity will be ventilated and no harm is done to the underlying structure, such as insulation 36 and beams 37.

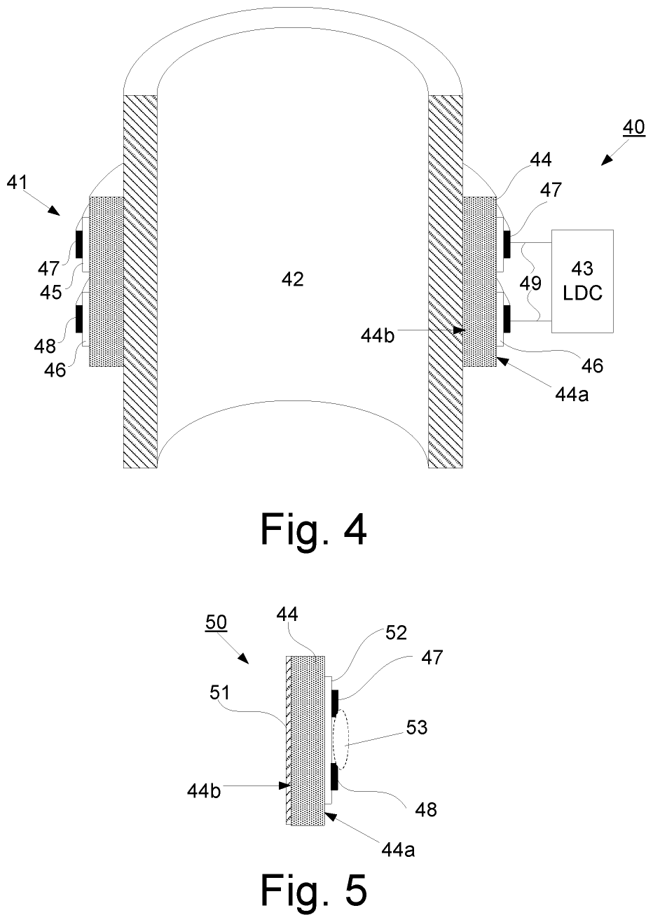

In order to prevent condensation to indicate leakage, detection of leakage may be obtained by a tape provided with partly insulated conductive wires arranged on a moisture absorbing material, preferably adhesive on one side, that is attached to the piping below the feed-through in the roof. This is illustrated in FIG. 4 below.

FIG. 4 illustrates a first example of a flexible tape 41 and leak detecting device 40 according to the present invention mounted on a conduit 42 with annular cross-section. The leak detecting device 40 comprises the flexible tape 41 and a Leak Detecting Circuit, LDC, 43. The flexible tape 41 comprises a first layer of an elongated substrate 44 formed from a moisture absorbent material, the substrate having a length L, a top surface 44a and a bottom surface 44b. A first and a second electrically insulating materials 45 and 46, which are also non-moisture absorbent, are disposed on the top surface 44a in separate second layers. A first electrical conductor 47 and a second electrical conductor 48 are spaced via the electrically insulating materials by arranging the first conductor 47 on top of the first insulating material 45 and the second conductor 48 on top of the second insulating material 46. The LDC 43 is connected to the first and second conductor 47 and 48 via wires 49, and is configured to indicate when a conductive bridge of liquid is formed between the conductors 47 and 48.

The non-moisture absorbent and the first and second electrically insulated material 45 and 46 will prevent the creation of a short-circuit connection between the conductors 47 and 48 when the moisture absorbent material in the substrate 44 absorbs conductive liquid. However, when the moisture absorbent material in the substrate 44 is saturated, drops of conductive liquid will eventually form and create a drop that will bridge the conductors 17 and 48 and the LDC 43 will detect a leakage (e.g. caused by non-ventilated condensation). The choice of moisture absorbent material, as well as physical dimensions of the substrate, will determine the amount of condensation necessary to saturate the substrate 44.

FIG. 5 illustrates a second example of a flexible tape 50 comprising a first layer of an elongated substrate 44 formed from a moisture absorbent material, the substrate having a length L, a top surface 44a and a bottom surface 44b. One electrically insulating material 52, which are also non-moisture absorbent, is disposed on the top surface 44a in a second layer. A first electrical conductor 47 and a second electrical conductor 48 are spaced via the electrically insulating material 52 by arranging the first conductor 47 spaced and parallel with the second conductor 48 on top of the insulating material 52. Furthermore, the flexible tape 50 may also be provided an adhesive layer 51 provided on the bottom surface 44b of the substrate 44. An adhesive layer may also be provided on the flexible tape described in connection with FIG. 4.

An electrically conductive fluid, or drop, 53 is shown by dashed lines to illustrate bridging of the conductors that will cause the LDC to detect a leak.

According to some embodiments, the first and second electrical conductors 47, 48 are parallel electrical conductors disposed on the at least one electrically insulating material 45, 46; 52.

According to some embodiments, the first and second electrical conductors 47, 48 are flat electrical conductors.

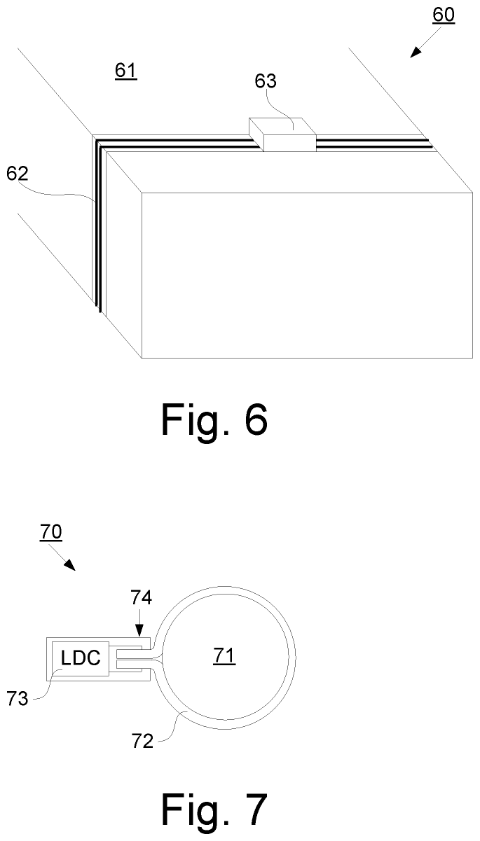

FIG. 6 illustrates a leak detecting device 60 according to the present invention mounted on a ventilation shaft 61 with rectangular cross-section, The leak detecting device 60 comprises a flexible tape 62 (as disclosed in connection with FIGS. 4 and 5) and a LDC 63. The bottom side is in this example provided with an adhesive layer used to glue the flexible tape 60 to the ventilation shaft 61. The LDC 63 is configured to contact the conductors of the flexible tape 60 and detect a reduction in electrical impedance between the conductors caused by the presence of a conductive fluid between the conductors.

FIG. 7 illustrates a leak detecting device 70, comprising a flexible tape 72 (as described in connection with FIGS. 4 and 5) mounted to a pipe 71 using a clamp 74 and a LDC 73. In this example, the flexible tape 72 is not provided with an adhesive layer and is instead held in place using the clamp 74. The clamp 74 has multiple purposes and also connects the conductors on the tape 72 to the LDC 73.

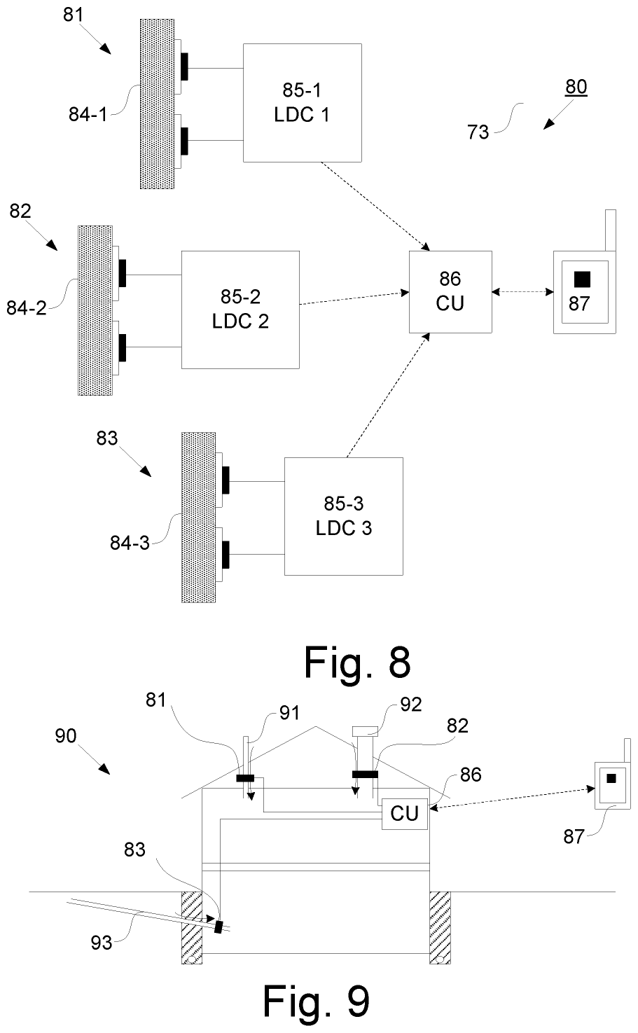

All leak detecting devices described above are also provided with a communication device (which may be integrated with the LDC) configured to provide an indication of a conductive fluid present between the first and the second electrical conductor. FIG. 8 illustrates a leak detection system 80 comprising a control unit 86 and three leak detecting devices 81, 82 and 83. Each leak detecting device comprises a flexible tape 84 (e.g. as described in connection with FIGS. 4 and 5), a leak detecting circuit, LDC, connected between the first and second electrical conductors 47, 48 of the flexible tape; and a communication device configured to provide an indication of a conductive fluid present between the first and second electrical conductors of the flexible tape. The leak detecting circuit being configured to detect a reduction in electrical impedance between the first and the second electrical conductors and to communicate the detected reduction in electrical impedance to the control unit 86 via the communication device, which may be integrated with the LDC.

The control unit 86 may be connected with the leak detecting devices 81-83 wirelessly, or wired. If connected wirelessly, each leak detecting device is configured to inform the control unit 86 of the battery status to ensure proper operations when a leak is detected. If connected by wire, the control unit may supply each leak detecting device with power.

According to some embodiments, the control unit 86 is connected to a user device 87 configured to receive an alarm from the control unit when a leak is detected, or when battery status is low. The alarm may further comprise information regarding which leak detecting device that has indicated a leak and/or has a low battery status.

FIG. 9 illustrates the leak detection system in FIG. 8 implemented in a building 90. The first leak detecting device 81 monitors the ventilation conduit 91 through the roof, the second leak detecting device 82 monitors the chimney 92 and the third leak detecting device 83 monitors the incoming water supply 93 through the wall of the basement of the house.

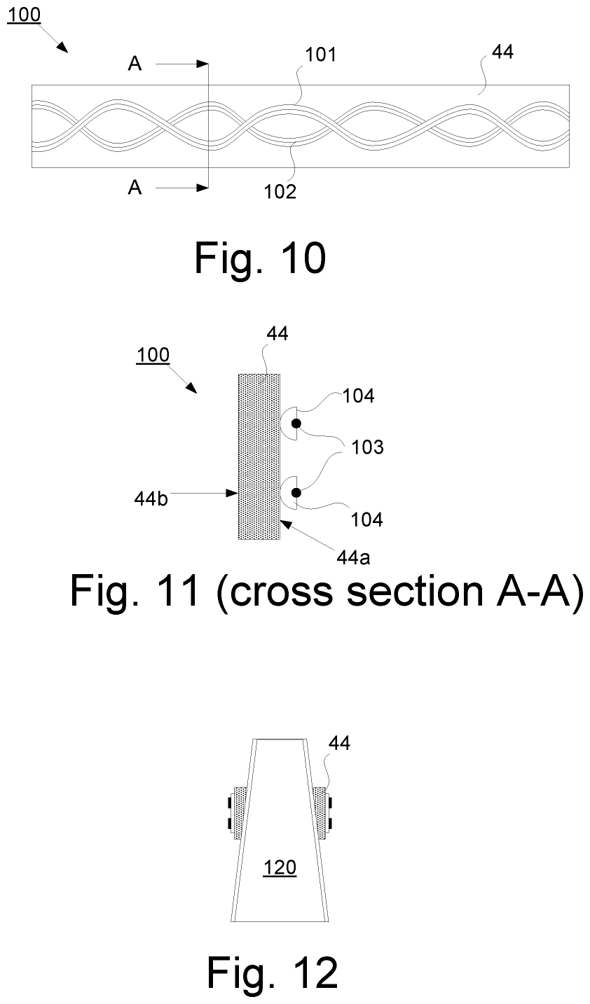

FIG. 10 illustrates a third example of a leak detection tape 100 according to the present invention comprising a first layer of an elongated substrate 44 formed from a moisture absorbent material, the substrate having a length L, a top surface 44a and a bottom surface 44b. In this embodiment, the conductors 103 are implemented in wires 101 and 102 each partially covered with a non-moisture absorbent, electrically insulating material 104 and disposed on the top surface 44a of the substrate 44 as a second layer. The wires 101 and 102 are arranged in a winding pattern across the top surface 44a.

FIG. 11 shows a cross-sectional view of the leak detection tape 100 in FIG. 10.

FIG. 12 illustrates an alternative embodiment of the leak detection tape 50 in FIG. 5. The conduit 120 has in this example a cylindrical shape with non-constant cross-sectional area. The substrate 44 is in this embodiment configured to be adaptable, by controlled deformation, to ensure good connection with the conduit 120 although the shape is not uniform.

As an example, the moisture absorbent material in the substrate of the tape may be a polymer, cellustic, fiber-based products (such as tissue paper, cotton, sponge, fluff pulp). The non-absorbent electrically insulating material may be any type of insulating material suitable for electrically insulating wires in a cable.

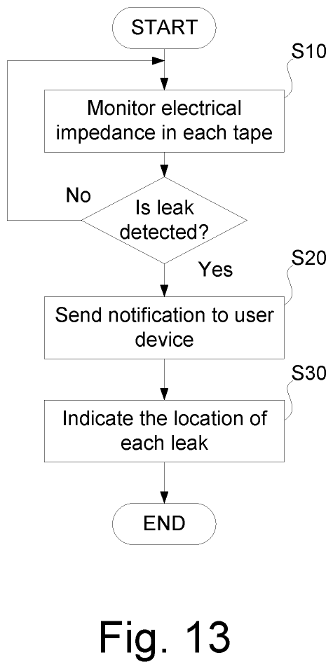

FIG. 13 illustrates a flow chart of a method for detecting a leak. The method is configured to detect the presence of an electrically conductive fluid between a first and a second electrical conductor in at least one flexible tape.

The method comprises monitoring S10 an electrical impedance between the first and second electrical conductors of each flexible tape in the leak detection system. When the electrical impedance in at least one of the flexible tapes is less than a predetermined threshold value, the method further comprises sending S20 a notification to a user device 87. Furthermore, the method also comprises indicating S30 the location of each flexible tape for which the impedance is less than the predetermined threshold value.

The methods described above may be implemented in a computer program for controlling a leakage detection system. The computer program comprises instructions which, when executed on at least one processor, cause the at least one processor to carry out the method according to the different variations described in connection with FIG. 13. The computer program for controlling the leakage detection system may be stored on and carried by a computer readable storage medium.

1. A flexible tape for use in detecting liquid leaks comprising:
an elongated substrate formed from a moisture absorbent material, the substrate having a length, a top surface, and a bottom surface;
at least one non-moisture absorbent, electrically insulating material disposed on the top surface; and
a first electrical conductor and a second electrical conductor spaced from the substrate via the at least one electrically insulating material.

2. The flexible tape according to claim 1, wherein the bottom surface is provided with an adhesive layer.

3. The flexible tape according to claim 1, wherein the first and the second electrical conductors are parallel electrical conductors disposed on the at least one electrically insulating material.

4. The flexible tape according to claim 3, wherein the first and the second electrical conductors are flat electrical conductors.

5. The flexible tape according to claim 1, wherein the first and the second electrical conductors are disposed on one electrically insulating material.

6. The flexible tape according to claim 1, wherein the first electrical conductor is disposed on a first electrically insulating material; and
wherein the second electrical conductor is disposed on a second electrically insulating material.

7. A leak detection system comprising:
a control unit;
at least one leak detecting device;
wherein each leak detecting device includes
a flexible tape according to claim 1,
a leak detecting circuit connected between the first and the second electrical conductors of the flexible tape, and
a communication device configured to provide an indication of a conductive fluid present between the first and the second electrical conductors of the flexible tape;
wherein the leak detecting circuit is configured to detect a reduction in electrical impedance between the first and the second electrical conductors and to communicate the detected reduction in electrical impedance to the control unit via the communication device.

8. A method for detecting presence of an electrically conductive fluid between a first electrical contractor and a second electrical conductor in at least one flexible tape, the method comprising:
monitoring an electrical impedance between the first and the second electrical conductors of each flexible tape;
sending a notification to a user device when the electrical impedance in at least one of the flexible tapes is less than a predetermined threshold value; and
indicating the location of each flexible tape when the impedance is less than the predetermined threshold value.

9. A computer program for detecting presence of an electrically conductive fluid between a first electrical conductor and a second electrical conductor, comprising instructions which, when executed on at least one processor, cause the at least one processor to carry out the method according to claim 8.

10. A computer-readable storage medium carrying a computer program for detecting presence of an electrically conductive fluid between a first electrical conductor and a second electrical conductor according to claim 9.
